(19) United States
(12) Patent Application Publication
(10) Pub. No.: US 2013/0117410 A1
(43) Pub. Date: May 9, 2013

(54) SYSTEM AND METHOD FOR MAPPING CONCURRENT READERS OF AN ELECTRONIC PUBLICATION

(71) Applicant: BARNESANDNOBLE.COM LLC, New York, NY (US)

(72) Inventor: Matthew PALLAKOFF, Mountain View, CA (US)

(73) Assignee: BARNESANDNOBLE.COM LLC, New York, NY (US)

(21) Appl. No.: 13/670,263

(22) Filed: Nov. 6, 2012

Related U.S. Application Data
(60) Provisional application No. 61/557,813, filed on Nov. 9, 2011.

(51) Int. Cl. G06F 15/16

(52) U.S. Cl. 709/217

(57) ABSTRACT

A system and method for use in connection with a reader for digital publication, such as electronic books, eBooks, or electronic magazines or newspapers. The system and method determines readers that are currently reading a specific section of a specific electronic publication and determines the location of those readers, The system and method then generates a. map, such as an image of the United States of America, or a globe, or even a simple text listing, that illustrates everyone else in a given geographic region (possibly the whole world) that is currently reading, or has recently finished reading, the specific part of the digital publication.

### FIELD OF THE INVENTION

The present invention generally relates to reading digital publications, and more particularly to systems that allow social interaction of readers of digital publications.

### BACKGROUND OF THE INVENTION

The advent of electronic readers, Which allow user to read books, periodicals, or whatever other material that previously had been available only through printed medium, opens new worlds of opportunity for social interaction regarding the written word.

SUMMARY OF THE INVENTION

The present invention operates in connection with a reader for digital publication, such as electronic books, eBooks, or electronic magazines or newspapers. The invention presents a map, such as an image of the United States of America, or a globe, or even a simple text listing, that illustrates everyone else in a given geographic region (possibly the whole world) that is currently reading, or has recently finished reading, a specific part of the digital publication.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates an exemplary system according to the present invention;

FIG. 2 depicts an exemplary user interface of the map according to the present invention; and

FIG. 3 illustrates the components of an exemplary device.

### DETAILED DESCRIPTION OF THE INVENTION

The invention presents a map on a user's electronic reader that illustrates, by location, other users who are currently reading, or have just finished reading, a specific part of the book or periodical the user is reading or has read.

As appreciated by those skilled in the art, the specific process for defining “a specific part” or “just finished” can vary by design. In some embodiments, the specific part could be a passage that the user is reading, or a specific page, or the current chapter, or a recipe in a cook book, or a specific article in a magazine, or anything within a certain distance of the area of the publication that the user currently viewing on her device at the moment. “Just finished” could be defined by a designer as anyone who has arrived at that position in the book within the last minutes and not yet turned past it, or anyone who has turned past that page in the last few minutes, or people who have specifically activated a user interface element indicating that they have finished that passage and wish to see (and be seen by) others who have just finished that passage, among other options.

Preferred embodiments of the present invention provide users with varying levels of control, so that a user's location, reading behavior or any other personal information is not exposed to others without their permission.

Simply seeing these other people displayed on the map in these other places, and knowing that they are experiencing the same thing at this moment can enhance a user's reading experience. Additionally, the map of the present invention can be used as a launching point for starting discussions, sharing recommendations, and conducting other interactions with those people who are engaging with the same content at the same time as the user.

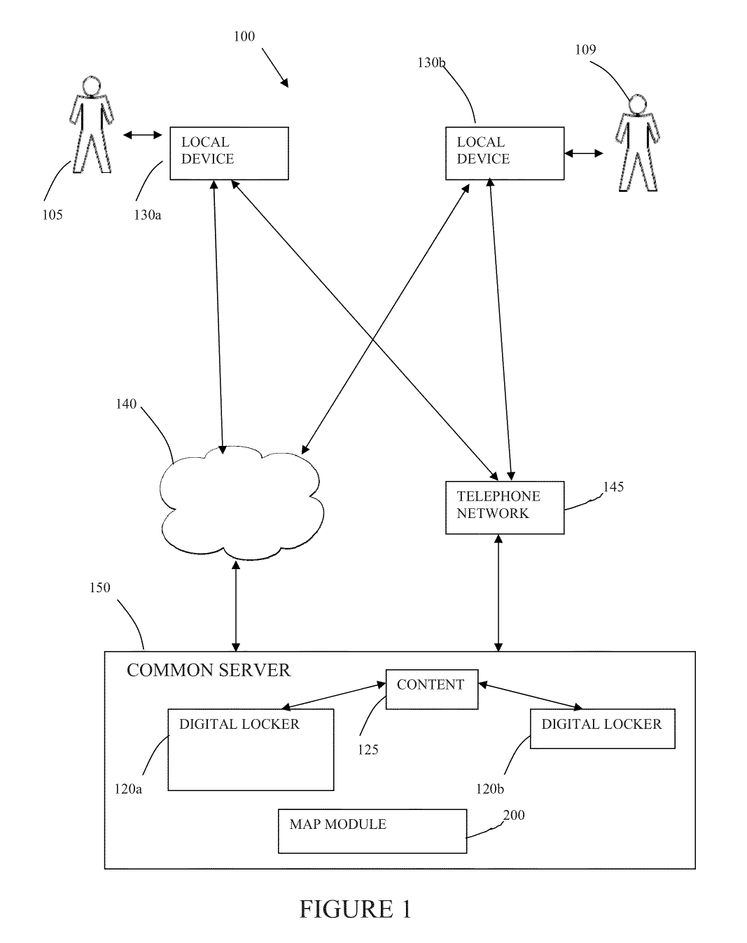

FIG. 1 shows components of a system 100 according to the present invention. User 105 is an authorized user of system 100 and uses her local device 130a for the reading of digital content and interacting with other users 109. Many of the functions of system 100 of the present invention are carried out on server 150. As appreciated by those skilled in the art, many of the functions described herein can be divided between the server 150 and the user's local device 130a. Further, as also appreciated by those skilled in the art, server 150 can be considered a “cloud” with respect to the user 105 and her local device 130a. As further appreciated by those skilled the art, the number of users able to use the system 100 is limited only by the capabilities of the cloud, which is easily configured to accommodate any number of users. The cloud can actually be comprised of several servers performing interconnected and distributed functions, For the sake of simplicity in the present discussion, only a single server 150 will be described. The user 105 can connect to the server 150 via the Internet 140, a telephone network 145 (e.g., wirelessly through a cellphone network) or other suitable electronic communication means. User 105 has an account on server 150, which authorizes user 105 to use system 100.

Associated with the user's 105 account is the user's 105 digital locker 120a located on the server 150. As further described below, in the preferred embodiment of the present invention, digital locker 120a contains links to copies of digital content 125 previously purchased (or otherwise legally acquired) by user 105.

Indicia of rights to all copies of digital content 125 owned by user 105, including digital content 125, is stored by reference in digital locker 120a. Digital locker 120a is a remote online repository that is uniquely associated with the user's 105 account. As appreciated by those skilled in the art, the actual copies of the digital content 125 are not necessarily stored in the user's locker 120a, but rather the locker 120a stores an indication of the rights of the user to the particular content 125 and a link or other reference to the actual digital content 125. Typically, the actual copy of the digital content 125 is stored in another mass storage (not shown). The digital lockers 120 of all of the users 105, 109 who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the server 150 can contain millions of files 125 containing digital content. It is also contemplated that the server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

Also contained in the user's digital locker 120a is her contacts list, in a preferred embodiment, the user's contact list will also indicate if the contact is also an authorized (registered) user of the system 100 with his or her own account on server 150. This information can be use by map module 200 to display to a user 105, her “friends,” contacts that are currently reading a specific piece of material as described herein.

User 105 can access his or her digital locker 120a using a local device 130a. Local device 130a is an electronic device such as a personal computer, an c-hook reader, a smart phone or other electronic device that the user 105 can use to access the server 150. In a preferred embodiment, the local device 130a has been previously associated, registered, with the user's 105 account on server 150 using user's 105 account credentials. Local device 130a provides the capability for user 105 to download user's 105 copy of digital content 125 via his or her digital locker 120a. After digital content 125 is downloaded to local device 130a, user 105 can engage with the downloaded content locally, e.g., read the book, listen to the music or watch the video.

In a preferred embodiment, local device 130a includes a non-browser based device interface that allows user 105 to initiate the mapping functionality of system 100 in a non-browser environment. Through the device interface, the user 105 is automatically connected to the server 150 in a non-browser based environment. This connection to the server 150 is a secure interface and can be through the telephone network 145, typically a cellular network for mobile devices. If user 105 is accessing his or her digital locker 120a using the Internet 140, local device 130a also includes a web account interface. Web account interface provides user 105 with browser-based access to his or her account and digital locker 120a over the Internet 140.

User 109 is also an authorized user of system 100. As with user 105, user 109 has an account with server 150, which authorizes user 109 to use system 100. As appreciated by those skilled in the art, the number of users 105, 109 that employ the present invention at the same time is only limited by the scalability of server 150. As with user 105, user 109 can access his or her digital locker 120b using her local device 130b. In a preferred embodiment, local device 130b is a device that user 109 has previously associated, registered, with his or her account using user's 109 account credentials, Local device 130b allows user 109 to download copies of his digital content 125 from digital locker 120b. User 109 can engage with downloaded digital content 125 locally on local device 130b.

In a preferred embodiment of the present invention, local devices 130a and 130b are capable of supplying enough data to identify their locations, at least approximately. These devices 130a, 130b are often connected to the cloud, most likely wirelessly, especially when using the mapping function of the present invention. Accordingly, the user's TP addresses or the IDs and strengths of the wireless networks the users can “see” can often be used to identify their approximate locations. However, other ways to locate users are possible, including Global Positioning System, GPS, receivers in some devices 130a, 130b. In an alternative embodiment, the user can specify her location in a user profile contained in her account 120a, 120b in server 150.

As users read their digital publications 125, when they are connected to the server 150, the local device 130a, 130b, transmits data to the server 150 regarding the user's geographical location as well as the particular content 125 the user is reading and the exact location within the content 125, e.g., page, that is being displayed on the device 130a, 130b.

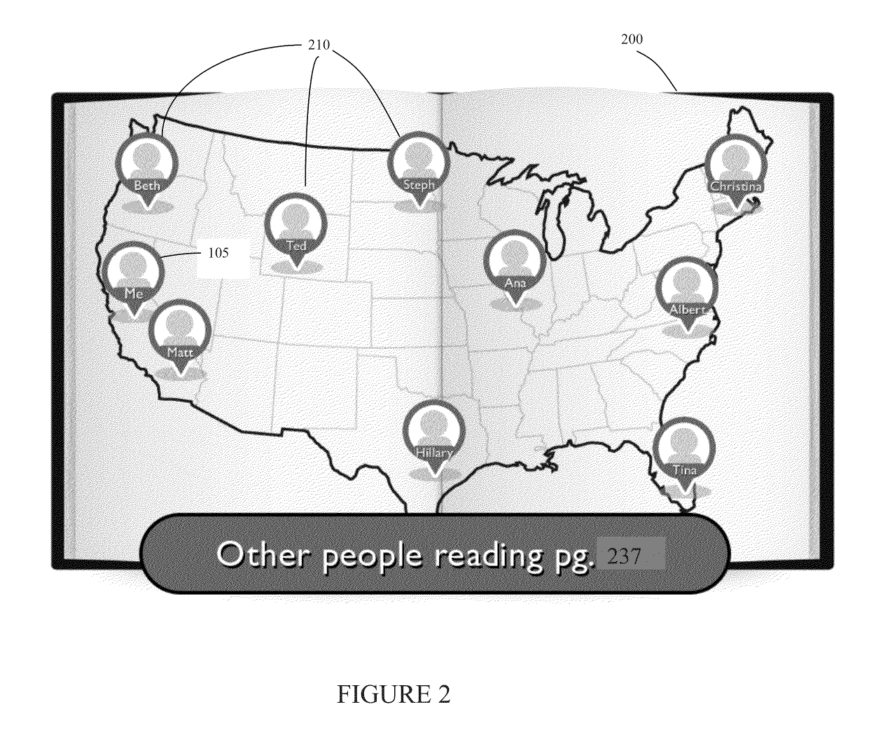

The Map Module 200 in server 150 tracks users, reading positions, and location information, so that it can either construct the “Map of Readers” images (see FIG. 2) on demand for each user, or feed the users' devices 130a, 130b the data that the device 130a, 130b requires to construct the maps locally.

The Map Module 200 can be designed to filter the data so that a user 105 only sees people that meet certain criteria, such as other people within this person's social network, e.g., “friends,” or only people who share an interest in certain genres of books, or other criteria. This can help reduce the amount of data delivered to the clients, and reduce the visual “noise” seen by the user 105. The designer may choose to give each user 105 control over some or all of those filters, such as the ability to only see which of their “friends” or book club mates have reached a given spot in a book. On the other hand, a designer may also choose to let each user 105 see a map of the whole world of all other readers who have reached that spot in the book.

In an operational example, a user 105 has just finished reading a moving or shocking passage in a novel 125, or the user 105 is on a particular recipe page in a cookbook 125 and has some questions. The user 105 selects the control, e.g., a button, that displays a pane on the user's device 130a containing a geographic map of other readers who are reading the same passage right now. The control for invoking the present invention can be incorporated into a “Who else is reading this?” option on an existing menu on the device 130a. For example, the user 105 could tap center of the screen of the ebook 125 she is reading to bring up the home menu and choose the “Who else is reading this?” selection from the menu.

Alternatively, a button, icon, can be placed directly on the user's screen for seeing who else is reading the same content 125, either in top left of page or somewhere in bottom margin of page. The icon can be toggled as being visible and being hidden, with other tool icons. Another alternative is to use a special gesture such as a two finger tap in the middle of the page of the eBook 125.

As appreciated by those skilled in the art, all of the users 105, 109 who are displayed on the map are connected to a common sever 150, network or servers or network, as described above, which allows the users' location to be displayed to others.

FIG. 2 depicts an exemplary map 200 produced by the present invention, It shows a map 200 of users 210 who have recently reached page 237 of the specific book 125 associated with this map 200. As described above, the information regarding the users' position in the content 125 and location is communicated from the users' devices 130 that are capable of reporting this information to the cloud 150. The map 200 includes someone named “Matt” in Southern California, someone named “Tina” in Florida, as well as the user 105 herself.

The map 200 of the present invention can be gently dynamic and display flashing points of light as people enter or leave this specific part of the book, and as they add comments to the discussion.

As noted above, there are several ways for the system 100 to determine the reader's approximate location, such as an IP address of the user's device 130, or having the user 105 self identify her location, or using subsystems that identify approximate locations based on which wireless signals are visible to the device, a Global Positioning System, GPS, device in the electronic device 130, or other such mechanisms.

There are also several ways for the system 100 to define and determine who is reading “this same passage.” This can be a bit complicated given the fact that pagination in an electronic publication can vary depending on font size, device 130 display size, line spacing and a user's particular device 130, among other factors. In one embodiment, the user's device 130 can determine what is the last character displayed on the screen for the page which the user 105 is currently viewing. If this defined as character position “X,” the user 105 wants to see on the map 200 anyone else that is on a page that includes that character position “X,” This definition of “this same passage” means that the other users 210 displayed on the map 200 have read, or are about to read, at least as far as position “X.”

The present invention allows the user 105 to filter what/who is being displayed on the map 200. In one embodiment, the user 105 can entirely turn off her visibility, or limit it to just her contacts. The user 105 is able to filter who they see—for example, toggle between “everyone in the world (who has enabled the feature),” “just friends,” “just people in or near my city” or “just people in my book club.”

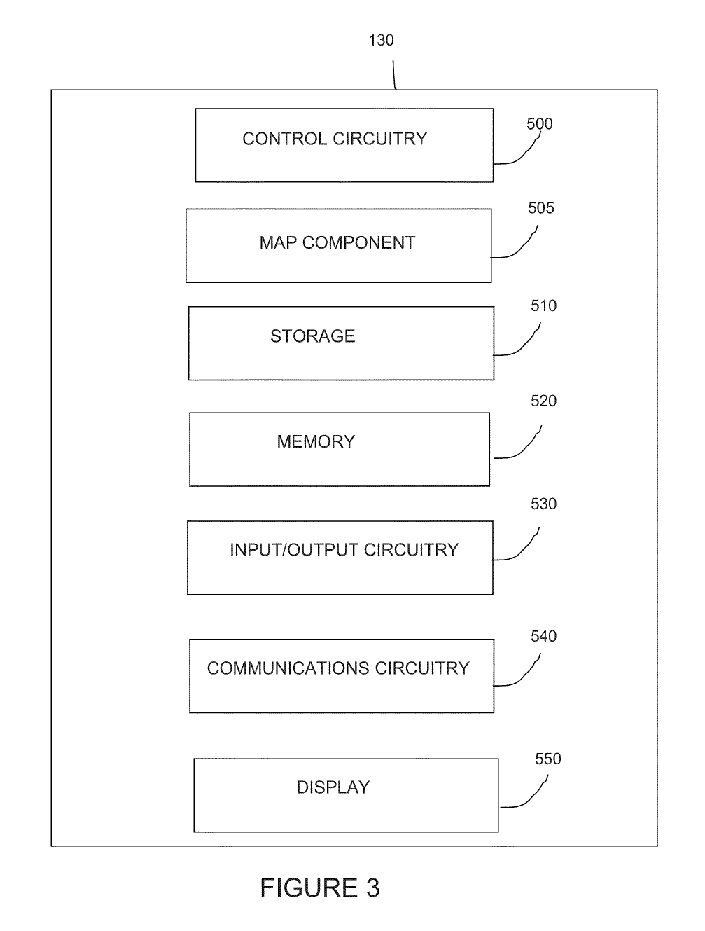

FIG. 3 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, storage 510 and memory 520 may be combined. As appreciated by those skilled in the art, electronic device 130 can include other components not combined or included in those shown in this Figure, a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Map component 505 includes at least the software and hardware for generating the map for display on electronic device 130, in a preferred embodiment, the map component also includes a UPS receiver as described above, for determining the location of the electronic device 130. This GPS data can be sent to the remote server 150 to inform the map module (200 in FIG. 1) of the location of the electronic device. in an alternative embodiment, the map component 505 can work with the communication circuitry 540 to send the remote server 540 information related to the wireless networks in the vicinity of the electronic device 130. As described above, the map component can simply display a map that is transmitted from the remote server 150, or can actually generate the map itself, based on the data sent to it by the remote server 150. Further, the map component 505 is capable of performing the filtering functions as described above.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g. libraries of data associated with authorized users, transaction information data, e.g., information such as credit card information, wireless connection information data, e.g., information that can enable electronic device 130 to establish a wireless connection), subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, 10 circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although 10 circuitry 530 is illustrated in this Figure as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen that is incorporated in electronics device 130. In some embodiments, the display circuitry can include a coder/decoder (Codec) to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can he operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can he operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in this Figure to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server, Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art, It is preferred, therefore, that the present invention be limited not by the specific disclosure herein, but only by the gist and scope of the disclosure.

What is claimed is

1. A method for operating an electronic device capable of displaying an electronic publication, the method comprising:
determining a section of the electronic publication currently displayed on the electronic device;
determining a geographic location of the electronic device;
establishing a connection with a remote server;
transmitting device data representing the section and the geographic location to the remote server;
receiving map data from the remote server, the map data identifying other electronic devices that are displaying the same section in the electronic publication and identifying the geographic location of the other electronic devices; and
displaying a map on the electronic device, the map indicating the geographic location of the other electronic devices.

2. The method according to claim 1, wherein the act of determining the section of the electronic publication currently displayed on the electronic device further comprises:
determining the last character displayed on a display screen of the electronic device.

3. The method according to claim 1, wherein the act of determining the geographic location of the electronic device further comprises:
determining an Internet Protocol address of the electronic device.

4. The method according to claim 1, wherein the act of determining the geographic location of the electronic device further comprises:
receiving location data from a Global Positioning System, GPS, device in the electronic device.

5. The method according to claim 1, further comprising:
filtering the map data to reduce the number of other electronic devices displayed on the map.

6. The method according to claim 5, wherein the act of filtering the map data further comprises:
identifying other electronic devices owned by users that have a relationship with flue owner of the electronic device.

7. The method according to claim 1, further comprising:
generating the map.

8. The method according to claim 7, wherein the act of generating the map further comprises:
generating the map on the electronic device.

9. The method according to claim 7, wherein the act of generating the map further comprises:
generating the map on the remote server.

10. A non-transitory computer-readable media comprising a plurality of instructions that, when executed by at least one electronic device, cause the at least one electronic device to:
determine a section of the electronic publication currently displayed on the at least one electronic device;
determine a geographic location of the at least one electronic device;
establish a connection with a remote server;
transmit device data representing the section and the geographic location to the remote server;
receive map data from the remote server, the map data identifying other electronic devices that are displaying the same section in the electronic publication and identifying the geographic location of the other electronic devices; and
display a map on the at least one electronic device, the map indicating the geographic location of the other electronic devices.

11. An electronic device comprising:
a memory that includes instructions for operating the electronic device and includes at least one electronic publication;
communication circuitry;
a display screen; and
control circuitry coupled to the memory, coupled to the communication circuitry and coupled to the display screen, the control circuitry executing the instructions and is operable to:
determine a section of the electronic publication currently displayed on the display screen;
determine a geographic location of the electronic device;
establish a connection with a remote server using the communication circuitry;
transmit device data over the established connection, the device data representing the section and the geographic location to the remote server;
receive map data from the remote server over the established connection, the map data identifying other electronic devices that are displaying the same section in the electronic publication and identifying the geographic location of the other electronic devices; and
display a map on the display screen, the map indicating the geographic location of the other electronic devices.

12. The electronic device according to claim 11, wherein the control circuitry executing the instructions for determining the section of the electronic publication currently displayed on the electronic device is further operable to:
determine the last character displayed on a display screen of the electronic device.

13. The electronic device according to claim 11, further comprising:
Global Positioning System, GPS, device coupled to the control circuitry, the GPS device providing the geographic location of the electronic device.

14. The electronic device according to claim 11, wherein the control circuitry executing the instructions is further operable to:
filter the map data to reduce the number of other electronic devices displayed on the map.

15. The electronic device according to claim 14, wherein the control circuitry executing the instructions is further operable to:
identify other electronic devices owned by users that have a relationship with the owner of the electronic device.

16. The electronic device according to claim 11, wherein the control circuitry executing the instructions is further operable to:
generate the map.

17. A system comprising:
a plurality of electronic devices, each electronic device comprising:
a memory that includes instructions for operating the electronic device and includes at least one electronic publication,
first communication circuitry,
a display screen, and
control circuitry coupled to the memory, coupled to the communication circuitry and coupled to the display screen; and
a remote server comprising:
second communication circuitry,
a plurality of digital lockers, each digital locker corresponding to a respective electronic device, each digital locker containing information related to electronic publications stored on the corresponding electronic device,
a map module coupled to the second communication circuitry and coupled to the plurality of digital lockers, the map module determining location information corresponding to locations of specific electronic devices and section information corresponding to a section of a specific electronic publication being displayed on the specific electronic devices,
wherein the remote server and the electronic devices communicate through the first and second communication circuitry and wherein the remote server transmits the location information and the section information to at least one of the electronic devices upon request.

18. The system according to claim 17, wherein the control circuitry in the at least one electronic device is operable to display a map on the display screen in response to the location information and the section information, the map indicating the geographic location of the specific electronic devices.

19. The system according to claim 17, wherein the at least one electronic device further comprises a Global Positioning System, GPS, device.

20. The system according to claim 17, wherein map module determines the location information from at least one of location data transmitted from the specific electronic devices; Internet Protocol addresses of the specific electronic devices and profile data contained in the digital lockers.
